(19) United States
(12) Patent Application Publication
(10) Pub. No.: US 2010/0147749 A1
(43) Pub. Date: Jun. 17, 2010

(54) Multi-Metallic Catalysts For Pre-Reforming Reactions

(75) Inventors: Pascal Tromeur, Wilmington, DE (US); Pavol Pranda, Hockessin, DE (US); Wei Huang, Newark, DE (US); Jingguang G. Chen, Hockessin, DE (US)

Correspondence Address: AIR LIQUIDE USA LLC;Intellectual Property, 2700 POST OAK BOULEVARD, SUITE 1800, HOUSTON, TX, 77056, US

(73) Assignee: American Air Liquide, Inc., Fremont, CA (US)

(21) Appl. No.: 12/635,145

(22) Filed: Dec. 10, 2009

Related U.S. Application Data
(60) Provisional application No. 61/121,611, filed on Dec. 11, 2008.

(51) Int. Cl. C10G 29/16; B01J 23/56; B01J 23/755; B01J 23/89; B01J 23/75

(52) U.S. Cl. 208/244; 502/326; 502/330; 502/337

(57) ABSTRACT

The present invention relates to multi-metallic catalyst compositions for improved coke resistance in a hydrocarbon feed pre-reformer unit that comprises nickel and an enhancing component selected from at least one member of the group consisting of ruthenium, palladium, platinum, rhodium, cobalt, gold and silver on a support. The present invention further relates to a catalyst system for improved coke and sulfur resistance in a hydrocarbon feed pre-reformer unit that comprises at least one multi-metallic catalyst composition comprising nickel and an enhancing component selected from at least one member of the group consisting of ruthenium, palladium, platinum, rhodium, cobalt, gold and silver on a support used in conjunction with at least one sulfur capturing component selected from the group comprising copper oxide and zinc oxide. Finally the present invention relates to the use of this catalyst system in a process for pre-reforming a hydrocarbon feed stream.

### CROSS-REFERENCE TO RELATED APPLICATIONS

This application claims the benefit of U.S. Provisional Application No. 61/121,611, filed Dec. 11, 2008, the entire contents of which are incorporated herein by reference.

### FIELD OF THE INVENTION

The present invention relates to multi-metallic catalyst compositions to be used in pre-reforming reactions to decrease coke and a catalyst system to be used in pre-reforming reactions to decrease coke and prevent sulfur poisoning.

### BACKGROUND

Hydrogen is manufactured for use in a wide variety of processes including hydrocracking-hydrotreating in petroleum refining, the manufacture of fine chemical products, as a raw material in the synthesis of ammonia and methanol, as an energy carrier in the space industry, and in an increasing number of demonstration projects for cars and buses fleets. Currently, 85% of the hydrogen manufactured on a worldwide basis is consumed by refineries (excluding the ammonia and methanol industries) and only a fraction of the hydrogen required by refineries is generated by the catalytic reforming process (producing high-octane gasoline). The remainder has to be generated by a supplementary hydrogen production facility. For this supplementary hydrogen production, on average 90% is generated by steam hydrocarbon reforming (hereinafter “SHR”) of hydrocarbon feed streams, of which steam methane reforming (hereinafter “SMR”) is the most utilized. In this process, heterogeneous nickel catalysts are the most commonly used catalysts for the treatment of the hydrocarbon feed streams. Due to the higher hydrocarbon content in refinery off-gas, and the natural gas becoming heavier recently, the installation of pre-reformers are increasing thereby making pre-reforming of the hydrocarbon feed streams an important step in the SHR process scheme.

In the pre-reformer, long chain (higher) hydrocarbons are converted by the steam reforming reaction to produce a mixture that includes hydrogen, carbon dioxide, carbon monoxide and methane. What has been found it that there are a number of benefits to installing a pre-reformer, including increasing production capacity, decreasing the size of the reformer furnace, feedstock flexibility, increased catalyst lifetime in the SHR unit, increased tube life in the SHR unit, a decrease in carbon formation and hot band in tubular reformers, an increase in advanced processes featuring low energy consumption and investment.

It is commonly accepted that the inevitable loss of catalytic activity in the pre-reformer unit and possibly downstream in the SHR unit is due to multiple failure modes with regard to the catalyst, all related to one another including, carbon formation, sulfur poisoning and sintering. This direct effect on the catalyst of the pre-reformer unit is the result of one or more of the modes noted above and the indirect effect on the catalyst of the SHR unit is typically due to failure of the pre-reformer unit to perform (failure to break clown the long chain carbons of the hydrocarbon feed stream) as required which in turn results in sulfur being passed to the SHR unit as well as sintering of the catalyst.

Sulfur has long been known to be a strong poison for nickel catalysts. It bonds strongly on the nickel active sites, thus blocking the desired reaction. Sulfur-containing compounds could reach the nickel surface at a ppb level and it accumulates at pre-reforming conditions. Therefore, even after a desulfurization of the feedstock, the sulfur adsorption capacity of the steam-reforming catalysts is still an important catalytic parameter.

Carbon formation may damage the catalyst pellets (or whatever form the catalyst may be in), block the active nickel sites, increase the pressure drop and even form on the reactor tubes resulting in a low heat transfer and tubing cracks. Three types of carbon deposition have been observed in the reformer: pyrolytic, encapsulating and whisker carbon.

Finally, sintering is also a critical issue for catalyst in general. It is a process in heterogeneous catalysts where small particles grow into big ones. The rate of sintering increases with temperature and it is also dependent on the atmosphere environment. If the sintering of catalyst can be prevent/minimized, the lifetime of catalyst will be greatly enhanced.

Steam reforming of hydrocarbons generally involves two catalytic steps: first, a metal surface for dissociative adsorption of hydrocarbons and; second, an oxide site for dissociative adsorption of water. Oxide sites include promoters and support. The catalyst must exhibit high thermal stability since the reforming process usually carried under high temperature and pressure. Moreover, because of the probability of deactivation by coke and carbon deposition, special designs for promoters and supports are important to enhance the gasification of carbon by steam. Therefore, pre-reforming catalyst design needs careful selections of active metal, support and promoters.

While utilizing a PR for pre-reforming prior to treatment in a SHR unit is known and a variety of catalysts have been developed and commercialized for use in the pre-reforming step, there still exists a need for better understanding of the catalyst reactions and an improved performance of these catalysts.

### SUMMARY OF THE INVENTION

The present invention relates to multi-metallic catalyst compositions for improved coke resistance in a hydrocarbon feed pre-reformer that comprises nickel and an enhancing component selected from at least one member of the group consisting of ruthenium, palladium, platinum, rhodium, cobalt, gold and silver on a support. The present invention further relates to a catalyst system for improved coke and sulfur resistance in a hydrocarbon feed pre-reformer unit that comprises at least one multi-metallic coke resistant catalyst composition comprising nickel and an enhancing component selected from at least one member of the group consisting of ruthenium, palladium, platinum, rhodium, cobalt, gold and silver on a support used in conjunction with at least one sulfur capturing component selected from the group comprising copper oxide and zinc oxide. Finally the present invention relates to the use of this catalyst system in a process for pre-reforming a hydrocarbon feed stream.

### BRIEF DESCRIPTION OF THE FIGURES

FIG. 1 provides FTIR of CO-chemisorption on freshly reduced Ni/γ-Al₂O₃ catalyst (prior art), after the first deactivation at 723° K. and after the second deactivation at 843° K.

FIG. 2 provides FTIR of CO-chemisorption on freshly reduced Ni—Ag/γ-Al₂O₃ catalyst, after first deactivation at 723° K. and after second deactivation at 843° K.

FIG. 3 provides FTIR of CO-chemisorption on freshly reduced Ni—Rh/γ-Al₂O₃ catalyst, after the first deactivation at 723° K. and after the second deactivation at 843° K.

FIG. 4 provides FTIR of CO-chemisorption on freshly reduced Ni—Pt/γ-Al₂O₃ catalyst, after first deactivation at 723° K. and after second deactivation at 843° K.

FIG. 5 provides FTIR of CO-chemisorption on freshly reduced Ni—Ru/γ-Al₂O₃ catalyst, after first deactivation at 723° K. and after second deactivation at 843° K.

FIG. 6 provides FTIR of CO-chemisorption on freshly reduced Ni—Co/γ-Al₂O₃ catalyst, after first deactivation at 723° K. and after second deactivation at 843° K.

FIG. 7 provides TEM of fresh Ni—Pt catalyst (left) and deactivated Ni—Pt catalyst (right).

FIG. 8 provides elemental analysis of fresh Ni—Pt catalyst (left) and deactivated Ni—Pt catalyst (right).

### DETAILED DESCRIPTION OF THE INVENTION

The present invention provides multi-metallic catalyst compositions for use in pre-reforming processes which provides better resistance to coke deposition, a catalyst system which includes one embodiment of the multi-metallic catalyst along with an sulfur capturing component to achieve a system which provides better resistance to coke deposition and sulfur poisoning and finally a process for pre-reforming utilizing the catalyst system.

The coke resistant catalyst composition of the present invention comprises a support having deposited thereon nickel enhanced with one or more enhancing components selected from ruthenium, palladium, platinum, rhodium, cobalt, gold and silver. The addition of one or more enhancing components to the nickel is to provide superior activity/coke resistance for the prepared coke resistant catalyst composition and to provide a cost efficient catalyst due to the possible minimization of enhancing components utilized.

As noted, the coke resistant catalyst composition of the present invention provides better resistance to coke deposition. As used herein, the phrases “improved coke resistance” and “better resistance to coke deposition” each refer to the ability of the coke resistant catalyst composition of the present invention to resist having coke deposited onto the catalyst thereby in effect inactivating the catalyst composition due to the coke blocking the active sites on the catalyst composition. This inactivating in turn could have an effect on the catalyst of the SHR unit located downstream of the pre-reformer unit.

The coke resistant catalyst composition of the present invention is utilized in hydrocarbon feed pre-reforming processes. The coke resistant catalyst composition comprises a support (also known as a carrier) on which nickel and one or more enhancing components selected from at least one member of the group consisting of ruthenium, palladium, platinum, rhodium, cobalt, gold and silver are deposited.

The support utilized to prepare the coke resistant catalyst composition of the present invention may be any support which is known to be utilized for preparing pre-reforming or reforming catalyst. More specifically, the support utilized may be selected from an alumina-, a silica-, or a titana-based compounds, or combinations thereof, such as alumina-silica carriers, from carbon-based materials such as, for example, charcoal, activated carbon, or fullerenes, piezo ceramics, technical porcelain, steatite, cordierite, mullite ceramics, carbides, silicon carbide, boron carbide, nitrides, silicon nitride, aluminum nitride, silicon aluminum oxynitride, calcium aluminate, potassium aluminate or magnesium aluminate, calcium oxide or combinations thereof. The support may be in any form known in the art. In one preferred embodiment, the support is mixed and then molded into the form to be used using any of the methods known in the art. Those supports with the highest surface area are the most preferred. More specifically, supports such as cylinders having one or more holes are one of the preferred forms.

The nickel added to the support may be added using a variety of different nickel precursors which are known to those skilled in the art. One or more of these nickel precursors are mixed with the support and then exposed to elevated temperatures to allow for decomposition and depositing of the nickel on the support. Non-limiting examples of the nickel precursors that may be used include, but are not limited to, nickel nitrate, nickel chloride and nickel acetate.

The enhancing components utilized in the coke resistant catalyst composition of the present invention include ruthenium, palladium, platinum, rhodium, cobalt, gold and silver, with palladium, platinum, gold and silver being the most preferred. As with the addition of nickel, the enhancing components are added through the use of one or more enhancing component precursors. In one embodiment of the present invention, the nickel is present with only one enhancing component. When the embodiment comprises nickel with only one enhancing component, preferably the enhancing component is selected from silver and gold, more preferably silver. In an alternative embodiment, the nickel is present with two or more enhancing components.

In this particular embodiment of the coke resistant catalyst composition, the nickel is present in an amount less than or equal to about 2.35 weight percent of the total coke resistant catalyst composition. Preferably the nickel is present in an amount from about 0.10 weight percent to about 2.35 weight percent of the total coke resistant catalyst composition. In the most preferred example of this particular embodiment, the nickel is present in an amount from about 1.50 to about 2.35, preferably from about 2.00 to about 2.35, weight percent of the total coke resistant catalyst composition.

The amount of enhancing component present will to some degree depend upon the type of enhancing component utilized and the number of enhancing components utilized. Typically, the molar ratio of the one or more enhancing components (total) to nickel in the coke resistant catalyst composition will range from about 1:10 to about 10:1, preferably from about 1:3 to about 1:9. In one preferred embodiment, only one enhancing component is utilized and this enhancing component is silver. Accordingly, when the only enhancing component present is silver, preferably the molar ratio of silver to nickel is from about 1:10 to about 10:1, preferably from about 1:3 to about 1:9.

The coke resistant catalyst composition of the present invention may be prepared by any variety of methods known to those skilled in the art, such as by precipitating the nickel and one or more enhancing components onto the support; spray-coating, kneading and/or impregnating the nickel and one or more enhancing components onto the support; and/or extruding the nickel and one or more enhancing components together with the support material to prepare catalyst extrudates. The most preferred method of preparation is to impregnate the nickel and one or more enhancing components onto a molded support having a high surface area.

In one embodiment of the present invention, the coke resistant catalyst composition is prepared by extrusion. The extrusion can be carried out using any conventional, commercially available extruder. For example, a screw-type extruding machine may be used to force the mixture comprising the support, the nickel precursor and the enhancing component precursor(s) through the orifices in a suitable dieplate to form the desired shape of extrudates. As the mixture is extruded, the strands can be cut to the desired length. After extrusion, the extrudates are dried preferably at an elevated temperature of up to about 500° C., more preferably up to about 300° C. The extrudates are typically dried for up to about 5 hours, more preferably from about 15 minutes to about 3 hours.

The extruded and dried coke resistant catalyst composition may then be expose to elevated temperatures to decompose the precursors, typically from about 200° C. to about 900° C., preferably at a temperature from about 400° C. to about 750° C., more preferably from about 500° C. to about 650° C. The thermal treatment can last from about 5 minutes to several hours, preferably from about 15 minutes to about 4 hours. When the thermal treatment is carried out, it may optionally be carried out in an oxygen-containing atmosphere, more preferably air. Those skilled in the art will recognize that the drying step and the thermal treatment step may be combined.

An alternative method for preparing the coke resistant catalyst composition of the present invention is by impregnating the nickel and one or more enhancing components onto a support. Typically the support is impregnated with a solution of a nickel precursor followed by a solution of the first enhancing component precursor and then subsequently by one or more solutions of any additional enhancing component precursors. In one embodiment, the support is impregnated simultaneously with the respective nickel and one or more enhancing components. Therefore, in this alternative embodiment, the nickel and one or more enhancing components are co-impregnated onto the carrier using a solution of a nickel precursor, a solution of a first enhancing component precursor and optionally one or more additional enhancing component precursors.

A still further method for preparing the coke resistant catalyst composition of the present invention involves first mixing the nickel precursor with the powdered support, extruding the nickel precursor/powdered support mixture, drying and subjecting the extrudate to elevated temperatures to decompose the precursor, and then impregnating the extrudate with the one or more enhancing component precursors to prepare coke resistant catalyst compositions for use in pre-reforming processes. In this particular embodiment, the extrusion, drying, thermal treatment and impregnating are as defined hereinbefore. Typically in this embodiment, the support is mixed with a nickel precursor and water followed by extrusion of the resulting mixture, and after drying and thermal treatment, impregnated with a solution of one or more enhancing components to prepare coke resistant catalyst composition extrudates. An alternative to this embodiment includes impregnating with a mixture of two or more enhancing components.

The present invention further provides for a catalyst system to be used in a pre-reformer unit. This catalyst system provides for improved coke and sulfur resistance in the hydrocarbon feed pre-reformer unit and as a result, possibly improved catalyst life in the SHR unit. The catalyst system comprises at least one multi-metallic coke resistant catalyst composition comprising nickel and an enhancing component selected from at least one member of the group consisting of ruthenium, palladium, platinum, rhodium, cobalt, gold and silver on a support, that is used in conjunction with at least one sulfur capturing component selected from the group comprising copper oxide and zinc oxide. The multi-metallic coke resistant catalyst compositions of the catalyst system is as described hereinbefore with the exception that in this particular embodiment of the present invention, the nickel is present in the coke resistant catalyst composition in an amount from about 0.10 to about 50 weight percent based on the total weight of the coke resistant catalyst composition. In one embodiment of the present invention, the nickel is present in the coke resistant catalyst composition in an amount from about 15 to about 45 weight percent based on the total weight of the coke resistant catalyst composition. In an even further embodiment, the nickel is present in the coke resistant catalyst composition in an amount from about 25 to about 40 weight percent based on the total weight of the coke resistant catalyst composition.

As noted above, the enhancing components are selected from ruthenium, palladium, platinum, rhodium, cobalt, gold and silver with the number of enhancing components being present ranging from coke resistant catalyst compositions that include nickel and only one enhancing component to coke resistant catalyst compositions that contain nickel and two or more enhancing components. The amount of enhancing component present will to some degree depend upon the amount of nickel present, the type of enhancing component utilized and the number of enhancing components utilized. Typically, the molar ratio of the one or more enhancing components present in the coke resistant catalyst composition to the nickel in the coke resistant catalyst composition (one or more enhancing components:nickel) is from about 1:10 to about 10:1, preferably from about 1:3 to about 1:9.

The catalyst system also contains a sulfur capturing component that is selected from zinc oxide, copper oxide and mixtures thereof. The presence of the sulfur capturing component provides sites at which any sulfur that may be present in the hydrocarbon stream to be treated will preferentially react, thereby allowing the active phase of the coke resistant catalyst composition to remain essentially sulfur free. In one embodiment of the present invention, the sulfur capturing component is zinc oxide. In an alternative embodiment of the present invention, the sulfur capturing component is copper oxide. When the sulfur capturing component is copper oxide, it is first necessary to activate the copper oxide so that it may be reduced to copper in order to allow for the copper to bind any of the species of sulfur that may be present in the hydrocarbon feed stream being treated. This activation is accomplished by reducing the copper oxide in situ by subjecting the copper oxide to a hydrogen rich stream prior to the actual steps of the pre-reforming process. Once the copper oxide is reduced, the copper oxide is then ready to be used in the pre-reforming process. Zinc oxide in its natural state is considered to be activated. Accordingly, it is not necessary to take additional action to reduce the zinc oxide in situ. In a still further embodiment of the present invention, the catalyst system will contain both zinc oxide and copper oxide. In this situation, the mixture of zinc oxide and copper oxide will also be subjected to a hydrogen rich stream in order to activate the copper oxide (reduce the copper oxide in situ to form activated copper).

One important aspect of the present invention is the proximity of the various components of the catalyst system (the multi-metallic coke resistant catalyst composition and the sulfur capturing component) to one another. In one embodiment of the present invention, the sulfur capturing component is physically separated from the coke resistant catalyst composition and is upstream from the coke resistant catalyst composition. In an alternative embodiment, the sulfur capturing component is physically separated from the coke resistant catalyst composition but is in close proximity to the catalyst component. In a still further embodiment, the sulfur capturing component and the coke resistant catalyst composition are actually touching, preferably in the form of a physical mixture.

In order to accomplish these embodiments, the catalyst system of the present invention may be in a variety of configurations. With regard to the embodiment where the sulfur capturing component is physically separated from the coke resistant catalyst composition, each of these components may be provided in their own individual fixed bed that is present in the pre-reformer unit. As noted, in this embodiment, the sulfur capturing component bed would be placed upstream from the coke resistant catalyst composition bed in order to minimize poisoning of the catalyst with sulfur that may be present in the hydrocarbon feed stream being treated. Accordingly, the hydrocarbon gas stream to be treated would first come into contact with the sulfur capturing component bed before being subjected to the catalyst component bed.

In the second noted embodiment, the sulfur capturing component is physically separated from the coke resistant catalyst composition but is in close proximity to the catalyst component. This may be accomplished by placing layers of the sulfur capturing component and the coke resistant catalyst composition in a fixed bed whereby the layers are in close proximity to one another but are not physically touching. As used herein, the phrase “in close proximity to one another” means that the two components do not physically touch but are disposed with regard to one another in such a manner that the nickel and enhancing components remain essentially sulfur free. As used herein, the phrase “essentially sulfur free” means that while trace amounts of sulfur may be present, the amount is not sufficient to block the active sites of the coke resistant catalyst composition. With regard to this alternative, this may be accomplished by placing the layers within the same fixed bed and separating the layers by a screen or similar device which allows for the flow of the feedstock between the layers but no actual physical touching or mixing of the layers.

In the final embodiment of the catalyst system, the sulfur capturing component and the coke resistant catalyst composition are actually touching. This may be accomplished in one of two manners. First, the coke resistant catalyst composition can be present in a fixed bed and layered on top of a layer of sulfur capturing component or the sulfur capturing component can be layered on top of a layer of coke resistant catalyst composition. With regard to this embodiment, there may be multiple layers of each (the coke resistant catalyst composition and the sulfur capturing component) present in the fixed bed depending upon the size of the pre-reformed unit, the size of the fixed bed and the amount of hydrocarbon gas to be treated. In this alternative, the catalyst system is in the form of a fixed catalyst bed comprising one or more layers of the multi-metallic coke resistant catalyst composition and one or more layers of the sulfur capturing component. Those of ordinary skill in the art will recognize that these layers may be in any form, including but not limited to pellets, cylinders, extrudables, Raschig rings, etc. Second, the coke resistant catalyst composition and sulfur capturing component can be mixed and then placed in a fixed bed.

The ratio of coke resistant catalyst composition to sulfur capturing component in the catalyst system will typically range from about 10:1 to about 1:10 although ranges outside of this range are also contemplated. In one preferred embodiment of the present invention the catalyst system comprises a coke resistant catalyst composition comprising from 25 to 40 weight percent nickel and one or more enhancing components selected from silver and gold along with zinc oxide where the coke resistant catalyst composition and sulfur capturing component are present in a ratio of from about 10:1 to about 1:10 and are present in a fixed bed with one or more layers of the catalyst component and one or more layers of the sulfur capturing component.

In another preferred embodiment, the catalyst system comprises a coke resistant catalyst composition comprising from 25 to 40 weight percent nickel and one or more enhancing components selected from silver and gold along with activated copper oxide (copper) where the coke resistant catalyst composition and sulfur capturing component are present in a ratio from about 10:1 to about 1:10 and are present in a fixed bed with one or more layers of the catalyst component and one or more layers of the sulfur capturing component.

In a still further preferred embodiment of the present invention, the catalyst system comprises a physical mixture of pellets of multi-metallic coke resistant catalyst composition and pellets of the sulfur capturing component. In this particular embodiment, the multi-metallic coke resistant catalyst compositions preferably comprise from 25 to 40 weight percent nickel and one or more enhancing components selected from silver and gold along with zinc oxide. The ratio of coke resistant catalyst composition to sulfur capturing component is preferably from about 10:1 to about 1:10 and the mixture is placed in a fixed bed.

The present invention also comprises a process for pre-reforming a hydrocarbon feed stream utilizing the catalyst system of the present invention prior to the hydrocarbon feed stream being injected into a steam hydrocarbon reforming unit. Pre-reforming is typically carried out in order to assist in obtaining a hydrocarbon stream that contains methane, carbon dioxide, hydrogen and carbon monoxide from a hydrocarbon stream containing higher hydrocarbons.

In the process of the present invention, the first step comprises providing the hydrocarbon feed stream source to be treated along with a heat exchanger and a pre-reformer unit. The hydrocarbon feed stream may be any hydrocarbon feed stream that is contemplated for treatment to produce a hydrogen rich effluent in a steam hydrocarbon reformer unit, preferably a steam methane reformer unit. With regard to equipment utilized to carry out the process of the present invention, a heat exchanger is needed in order to heat the hydrocarbon feed stream to a temperature from about 300° C. to about 700° C. prior to this hydrocarbon feed stream being injected into the pre-reformer unit. Heat exchangers of the type that may be utilized are readily known to those skilled in the art any may comprise any number of prior art heat exchangers. In addition to the heat exchanger, a pre-reformer unit is utilized that comprises a pre-reformer vessel, a gas inlet, a gas outlet and a catalyst system disposed within the pre-reformer vessel between the gas inlet and the gas outlet. Those skilled in the art will recognize that the structural aspects of the pre-reformer unit with regard to the vessel, gas inlet and gas outlet, may be any of those that are readily known in the art. In addition, while the pre-reformer unit is described with regard to a limited number of structural components, those skilled in the art will recognize that any structural components that are found in pre-reformer units may be utilized in the pre-reformer unit of the present invention.

The catalyst system utilized in the pre-reformer unit is the catalyst system as described hereinbefore. As noted previously, the catalyst system comprises at least one multi-metallic coke resistant catalyst composition comprising nickel and an enhancing component selected from at least one member of the group consisting of ruthenium, palladium, platinum, rhodium, cobalt, gold and silver on a support, and at least one sulfur capturing component selected from the group consisting of copper oxide and zinc oxide, with the proviso that when copper oxide is utilized, the copper oxide is first activated as described hereinbefore prior to the hydrocarbon feed stream being treated in the pre-reformer unit.

The second step of the process comprises injecting the hydrocarbon feed stream into at least one heat exchanger to heat the hydrocarbon feed stream to a temperature that ranges from about 300° C. to about 700° C. The hydrocarbon feed stream is heated as it is passed through the one or more heat exchangers in order to produce a heated hydrocarbon feed stream. The heated hydrocarbon feed stream is withdrawn and passed to the gas inlet of the pre-reformer unit where the gas then enters the vessel of the pre-reformer unit. Once the heated hydrocarbon feed stream is injected into the pre-reformer unit, the heated hydrocarbon feed stream is brought into contact with the catalyst system of the pre-reformer vessel. As a result of this contact, there is a reduction in the amount of sulfur in the hydrocarbon feed stream and a decrease in the amount of coke typically caused by the pre-reforming step. As a result, there is produced a sulfur free hydrocarbon feed stream. This sulfur free hydrocarbon feed stream is withdrawn from the vessel of the pre-reformer unit through the gas outlet of the vessel and is passed on for further treatment in a steam hydrocarbon reforming unit.

### EXAMPLES

### Comparative Example 1

### Ni Mono-Metallic Catalyst

Ni catalyst (1.5 wt %) on γ-Al₂O₃ Support was synthesized using the incipient wetness method. After being reduced in a H₂ environment, Fourier transform infrared (FTIR) spectroscopy of CO adsorption was used to probe the surface properties of the fresh catalyst. The catalyst was then deactivated in the environment of 10 torr ethane and 1 torr H₂ at 723° K. for 20 minutes and then at 843° K. for 20 minutes. Following deactivation at each temperature, CO adsorption, both with background CO and without background CO was applied to determine the degree of deactivation of the catalyst.

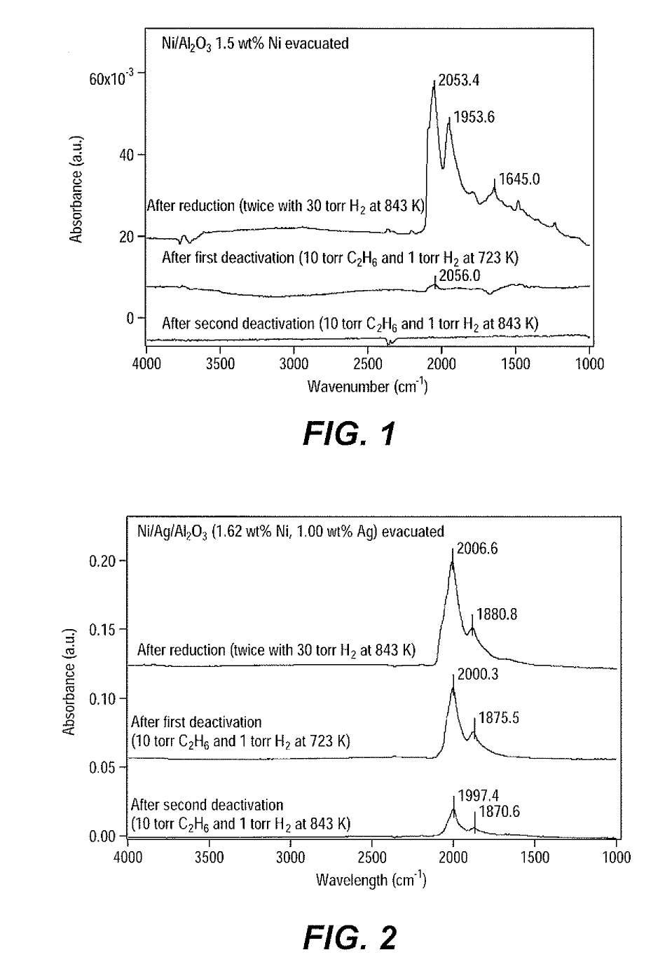

FIG. 1 shows only the chemisorbed CO on Ni surfaces after pumping away the gas phase CO. Results from FIG. 2 show that only small amounts of Ni sites are detected after deactivation at 723° K., but all sites disappeared after the catalyst was deactivated after 843° K. which means that the catalyst was completely deactivated.

### Example 1

### Ni—Ag Bimetallic Catalyst

Ni—Ag (1.62 wt % Ni, 1 wt % Ag, molar ratio of Ag/Ni is ˜1:3) bimetallic catalyst on γ-Al₂O support was synthesized using the incipient wetness method. After being reduced in H₂ environment, FTIR spectroscopy of CO adsorption was used to probe the surface properties of the fresh catalyst. Then the catalyst was deactivated in the environment of 10 torr ethane and 1 torr H₂ at 723° K. for 20 minutes and then at 843° K. for 20 minutes. Following deactivation at each temperature, CO adsorption without background CO was applied to determine the degree of deactivation of the catalyst. FIG. 2 shows the chemisorbed CO on Ag surfaces after pumping away the gas phase CO. Results from FIG. 2 show that significant amounts of metal sites are detected on Ni—Ag bimetallic catalyst after deactivation at both 723° K. and 843° K., which means that the Ni—Ag bimetallic catalyst is coke-resistant compared to the Ni mono-metallic catalyst of Comparative Example 1.

### Example 2

### Ni—Rh Bimetallic Catalyst

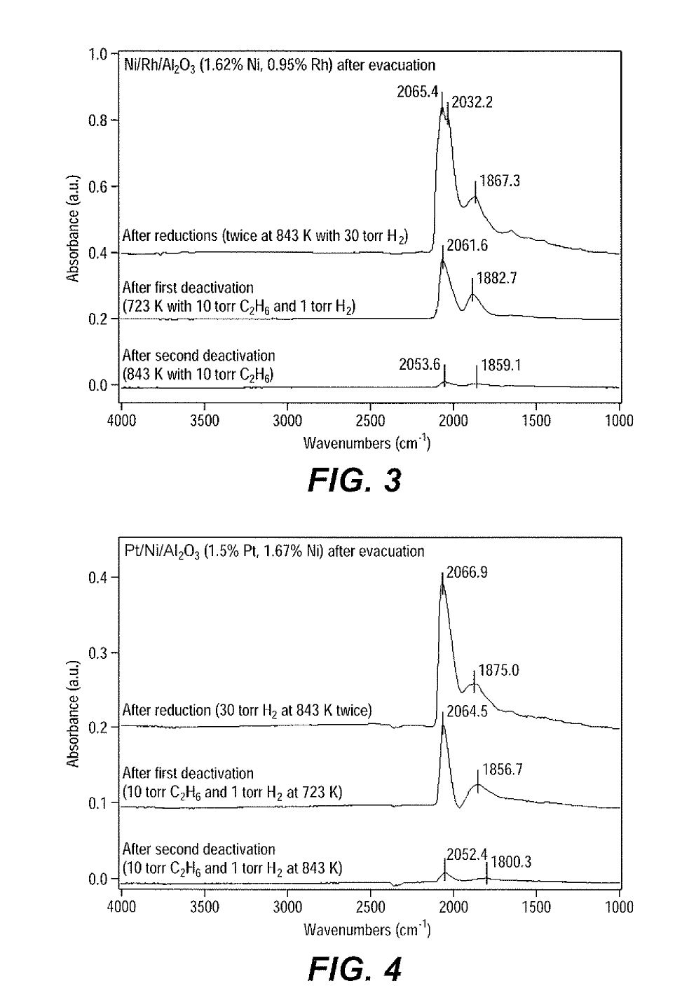

Ni—Rh (1.62 wt % Ni, 0.95 wt % Rh, molar ratio of Rh/Ni is ˜1:3) bimetallic catalyst on γ-Al₂O₃ support was synthesized using the incipient wetness method. After reduced in H₂ environment, FTIR spectroscopy of CO adsorption was used to probe the surface properties of the fresh catalysts. Then the catalyst was deactivated in the environment of 10 torr ethane and 1 torr H₂ at 723° K. for 20 minutes and then at 843° K. for 20 minutes. Following the deactivation at each temperature. CO adsorption without background CO was applied to determine the degree of deactivation of the catalyst. FIG. 3 shows the chemisorbed CO on Ni—Rh surfaces after pumping away the gas phase CO. Results from FIG. 3 show that significant amounts of metal sites are detected on Ni—Rh bimetallic catalyst after deactivation at 723° K. and small amounts of metal sites are detected after deactivation at 843° K. The Ni—Rh bimetallic catalyst shows better coke-resistant compared to the Ni mono-metallic catalyst of Comparative Example 1.

### Example 3

### Ni—Pt Bimetallic Catalyst

Ni—Pt (1.67 wt % Ni, 1.5 wt % Pt, molar ratio of Pt/Ni is ˜1:3) bimetallic catalyst on γ-Al₂O₃ support was synthesized using the incipient wetness method. After being reduced in H₂ environment, FTIR spectroscopy of CO adsorption was used to probe the surface properties of the fresh catalyst. The catalyst was then deactivated in the environment of 10 torr ethane and 1 torr H₂ at 723° K. for 20 minutes and then 843° K. for 20 minutes. Following the deactivation at each temperature, CO adsorption without background CO was applied to determine the degree of deactivation of the catalyst. FIG. 4 shows the chemisorbed CO on Ni Pt surfaces after pumping away the gas phase CO. Results from FIG. 4 show that significant amounts of metal sites are detected on Ni—Pt bimetallic catalyst after deactivation at 723° K. and small amounts of metal sites are detected after deactivation at 843° K. The Ni—Pt bimetallic catalyst shows better coke-resistant compared to the Ni mono-metallic catalyst of Comparative Example 1.

### Example 4

### Ni—Ru Bimetallic Catalyst

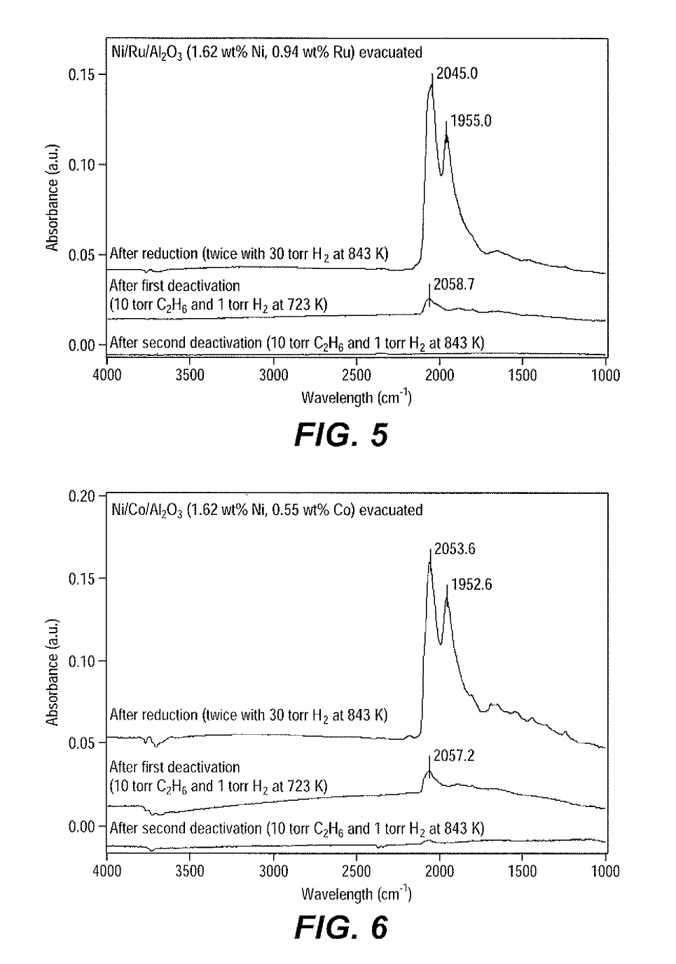

Ni—Ru (1.62 wt % Ni, 0.94 wt % Ru, molar ratio of Ru/Ni is ˜1:3) bimetallic catalyst on γ-Al₂O₃ support was synthesized using the incipient wetness method. After being reduced in H₂ environment, FTIR spectroscopy of CO adsorption was used to probe the surface properties of the fresh catalyst. The catalyst was then deactivated in the environment of 10 torr ethane and 1 torr H₂ at 723° K. for 20 minutes and then at 843° K. for 20 minutes. Following deactivation at each temperature, CO adsorption without background CO was applied to determine the degree of deactivation of the catalyst. FIG. 5 shows the chemisorbed CO on Ni—Ru surfaces after pumping away the gas phase CO. Results from FIG. 5 show that small amounts of metal sites are detected on Ni—Ru bimetallic catalyst after deactivation at 723° K. and no metal sites are detected after deactivation at 843° K., which means the Ni—Ru catalyst is completely deactivated at 843° K. The Ni—Ru bimetallic catalyst shows little improvement of coke-resistant compared to the Ni mono-metallic catalyst of Comparative Example 1.

### Example 5

### Ni—Co Bimetallic Catalyst

Ni—Co (1.62 wt % Ni, 0.55 wt % Co, molar ratio of Co/Ni is ˜1:3) bimetallic catalyst on γ-Al₂O₃ support was synthesized using the incipient wetness method. After being reduced in H₂ environment, FTIR spectroscopy of CO adsorption was used to probe the surface properties of the fresh catalyst. The catalyst was then deactivated in the environment of 10 torr ethane and 1 torr H₂ at 723° K. for 20 minutes and then at 843° K. for 20 minutes. Following deactivation at each temperature, CO adsorption without background CO was applied to determine the degree of deactivation of the catalyst. FIG. 6 shows the chemisorbed CO on Ni—Co surfaces after pumping away the gas phase CO. Results from FIG. 6 show that small amounts of metal sites are detected on Ni—Co bimetallic catalyst after deactivation at 723° K. and no metal sites are detected after deactivation at 843° K., which means the Ni—Co catalyst is completely deactivated at 843° K. The Ni—Co bimetallic catalyst shows little improvement of coke-resistant compared to the Ni mono-metallic catalyst of Comparative Example 1.

### Example 6

### Transmission Electron Microscopy (TEM) and Elemental Analysis of Ni—Pt Bimetallic Catalyst Before and after Deactivation

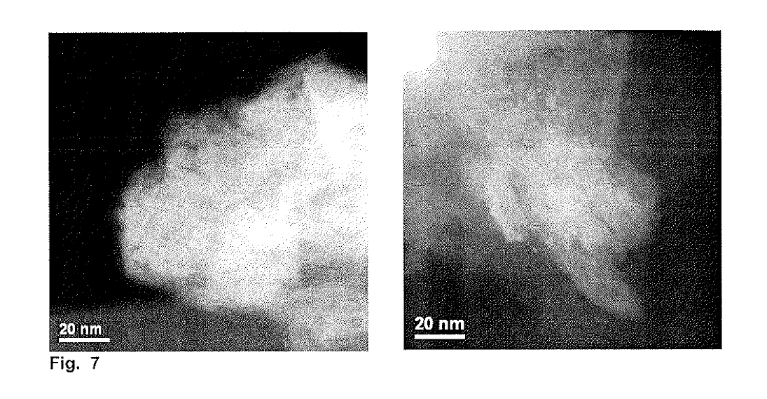

FIG. 7 shows the TEM image of fresh Ni—Pt catalyst and deactivated Ni—Pt catalyst. It clearly shows that the metal particle size did not change before and after deactivation, which indicates that the change of adsorption of CO is not due to the structure change of the catalyst.

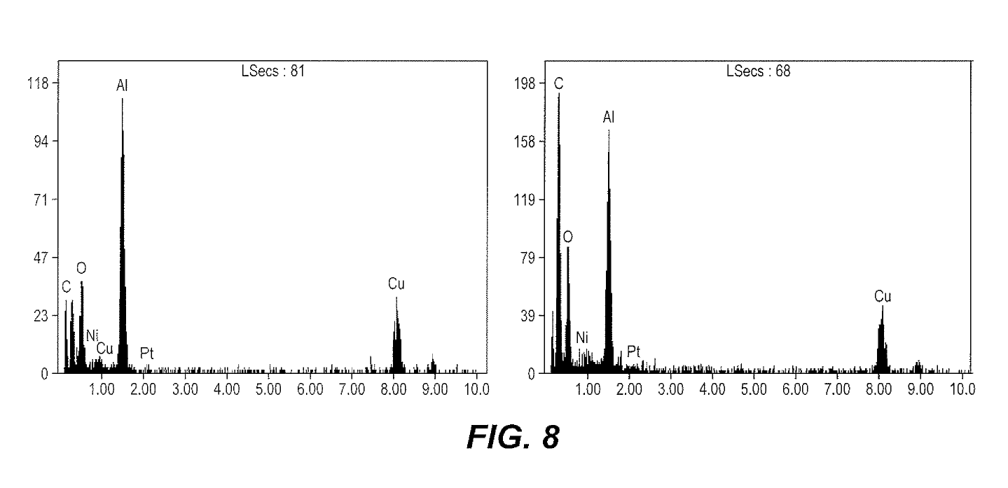

As shown in FIG. 8, there was much higher carbon concentration in deactivated Ni—Pt catalyst compared to the fresh Ni—Pt catalyst, which indicates that carbon was formed during the deactivation process. Elemental analysis of the fresh and deactivated Ni—Pt catalyst confirmed that the deactivation of catalyst is due to coke formation.

What is claimed:

1. A multi-metallic catalyst composition for improved coke resistance in a hydrocarbon feed pre-reformer, the composition comprising nickel and an enhancing component selected from at least one member of the group consisting of ruthenium, palladium, platinum, rhodium, cobalt, gold and silver on a support, the nickel being present in an amount from 0.10 to 2.35 weight percent of the coke resistant catalyst composition.

2. The catalyst composition of claim 1, wherein the enhancing component is silver.

3. The catalyst composition of claim 2, wherein the nickel is present in an amount from 2.00 to 2.35 weight percent of the coke resistant catalyst composition.

4. The catalyst composition of claim 3, wherein the silver is present in a molar ratio of silver to nickel from 1:3 to 1:9.

5. A catalyst system for improved coke and sulfur resistance in a hydrocarbon feed pre-reformer unit, the catalyst system comprising at least one multi-metallic catalyst composition comprising nickel and an enhancing component selected from at least one member of the group consisting of ruthenium, palladium, platinum, rhodium, cobalt, gold and silver on a support, the nickel being present in the catalyst composition in an amount from 0.1 to 50 weight percent; used in conjunction with at least one sulfur capturing component selected from the group comprising copper oxide and zinc oxide, with the proviso that when the sulfur capturing component is copper oxide, the copper oxide is activated copper oxide.

6. The catalyst system of claim 5, wherein the nickel is present in the catalyst composition in an amount from 15 to 45 weight percent.

7. The catalyst system of claim 6, wherein the nickel is present in the coke resistant catalyst composition in an amount from 25 to 40 weight percent.

8. The catalyst system of claim 5, wherein the catalyst system is in the form of a fixed catalyst bed comprising one or more layers of the multi-metallic catalyst composition and one or more layers of the sulfur capturing component.

9. The catalyst system of claim 8, wherein the ratio of catalyst composition to sulfur capturing component in the catalyst system ranges from 10:1 to 1:10.

10. The catalyst system of claim 9, wherein the enhancing metal component in present in the catalyst composition in a molar ratio of enhancing metal component to nickel of from 1:10 to 10:1.

11. The catalyst system of claim 10, wherein the catalyst composition comprises nickel and silver.

12. The catalyst system of claim 11, wherein the sulfur capturing component is activated copper oxide.

13. The catalyst system of claim 11, wherein the sulfur capturing component is zinc oxide.

14. The catalyst system of claim 12, wherein the nickel is present in the catalyst composition in an amount from 25 to 40 weight percent.

15. The catalyst system of claim 13, wherein the nickel is present in the catalyst composition in an amount from 25 to 40 weight percent.

16. The catalyst system of claim 5, wherein the catalyst system is in the form of a physical mixture of pellets of multi-metallic catalyst composition and pellets of the sulfur capturing component.

17. The catalyst system of claim 16, wherein the molar ratio of catalyst composition to sulfur capturing component in the catalyst system ranges from 10:1 to 1:10.

18. The catalyst system of claim 17, wherein the enhancing metal component is present in the catalyst composition in a molar ratio of one or more enhancing components to nickel of from 1:10 to 10:1.

19. The catalyst system of claim 18, wherein the catalyst composition comprises nickel and silver.

20. The catalyst system of claim 19, wherein the sulfur capturing component is activated copper oxide.

21. The catalyst system of claim 19, wherein the sulfur capturing component is zinc oxide.

22. The catalyst system of claim 20, wherein the nickel is present in the catalyst composition in an amount from 25 to 40 weight percent.

23. The catalyst system of claim 21, wherein the nickel is present in the catalyst composition in an amount from 25 to 40 weight percent.

24. A process for pre-reforming a hydrocarbon feed stream prior to the hydrocarbon feed stream being injected into a steam hydrocarbon reforming unit, the process comprising the steps of:
(a) providing a hydrocarbon feed stream source, a heat exchanger to heat the hydrocarbon feed stream source and a pre-reformer unit comprising a pre-reformer vessel, a gas inlet, a gas outlet and a catalyst system disposed within the pre-reformer vessel, the catalyst system comprising:
(i) at least one multi-metallic coke resistant catalyst composition comprising nickel and an enhancing component selected from at least one member of the group consisting of ruthenium, palladium, platinum, rhodium, cobalt, gold and silver on a support, the nickel being present in the coke resistant catalyst composition in an amount from 0.1 to 50 weight percent; and
(ii) at least one sulfur capturing component selected from the group comprising copper oxide and zinc oxide;
(b) injecting the hydrocarbon feed stream into the heat exchanger and heating the hydrocarbon feed stream to a temperature that ranges from 300 to 700 C;
(c) withdrawing the heated hydrocarbon feed stream from the heat exchanger and injecting the heated hydrocarbon feed stream into the pre-reformer vessel; and
(d) bringing the heated hydrocarbon feed stream into contact with the catalyst system of the pre-reformer vessel in order to decrease the amount of sulfur in the hydrocarbon feed stream and decrease the amount of coke typically caused by the pre-reforming step thereby producing a sulfur free hydrocarbon feed stream; and
(e) withdrawing the sulfur free hydrocarbon feed stream and passing it on for further treatment in a steam hydrocarbon reforming unit.
